(19) United States
(12) Patent Application Publication
(10) Pub. No.: US 2011/0140873 A1
(43) Pub. Date: Jun. 16, 2011

(54) NAVIGATION SYSTEM FOR A COMPLEX, MENU-CONTROLLED, MULTIFUNCTIONAL VEHICLE SYSTEM

(75) Inventors: Ulrich Stählin, Eschborn (DE); Peter Rieth, Eltville (DE); Sighard Schräbler, Frankfurt (DE); Marc Menzel, Marburg (DE); Andreas Schirling, Pfungstadt (DE); Robert Baier, Dieburg (DE); Robert Gee, Lake Barrington, IL (US)

(73) Assignee: Continental Teves AG & Co. oHG, Frankfurt (DE)

(21) Appl. No.: 12/891,142

(22) Filed: Sep. 27, 2010

Related U.S. Application Data
(63) Continuation of application No. 12/676,270, now abandoned.

(30) Foreign Application Priority Data
Sep. 4, 2007 (DE) 10 2007 041761.8
Aug. 15, 2008 (DE) 10 2008 037882.8

(51) Int. Cl. B60Q 1/00

(52) U.S. Cl. 340/438

(57) ABSTRACT

A system and method for a navigation system for a complex menu-controlled multifunctional vehicle control system. The system has a navigation unit and a man-machine interface which are arranged separately at different locations in the vehicle. Between the two units there is a communication link which is of bidirectional design.

### CROSS REFERENCE TO RELATED APPLICATIONS

This application is a continuation of co-pending U.S. application Ser. No. 12/676,270 filed Mar. 3, 2010, which claims priority of PCT International Application No. PCT/EP2008/060769, filed Aug. 15, 2008, which claims priority to German Patent Application No. 10 2007 041 761.8, filed Sep. 4, 2007 and German Patent Application No. 10 2008 037 882.8, filed Aug. 15, 2008, the contents of such applications being incorporated by reference herein.

### BACKGROUND OF THE INVENTION

1. Field of the Invention

The invention relates to navigation engineering for vehicles. In particular, the invention relates to a navigation system for a complex menu-controlled multifunctional vehicle system, a vehicle having such a navigation system, the use of such a navigation system in a vehicle, a method for assisting a driver of a vehicle, a program element and a computer-readable medium.

2. Technology Background

Conventionally, functional components in vehicles, such as onboard computer, air-conditioning system, radio, navigation system, etc., are installed in the vehicle as individual components which can be operated separately. Each individual component has a dedicated operator control panel, which means that the driver needs to turn towards the operator control component or feel for the operator control element while driving in order to operate the individual components. This often distracts the driver from what is happening in the traffic.

In addition, selected operator control elements for individual components, such as the call acceptance for a mobile telephone, the volume control and the program selection key for a radio, may be arranged physically separate from the individual components within reach of the driver, particularly in proximity to the steering wheel or on the steering wheel itself. However, this often only makes sense when the vehicle is first fitted out. In addition, the outlay is relatively high.

In addition, individual components can be combined to form a complex menu-controlled multifunctional vehicle system. In this case, the operator control is concentrated in an operator control interface of the multifunctional vehicle system. By way of example, such a multifunctional system is installed in the region of the conventional radio installation slot and combines the functions of onboard computer, air-conditioning system, radio and navigation appliance. The display of the multifunctional system may be in the form of a sensitive input screen (touch screen display) in order to allow menu items to be input by touching the display. Alternatively, operator control elements can be arranged directly adjacent to the display.

The rising complexity of such menu-controlled multifunctional vehicle systems requires that the user turn directly towards the operator control interface for the purpose of operator control and therefore involves the risk of distraction from driving.

Normally, navigation appliances involve both the actual navigation (map, map matching, routing, etc.) and the man-machine interface (which is responsible for the presentation, that is to say the graphical and audible output of the information, for the user's inputs, etc.) being combined in an appliance.

### SUMMARY OF THE INVENTION

It is an object of at least one aspect of the invention to provide an improved navigation system which allows safe operation.

In one or more embodiments, the invention specifies a navigation system for a complex menu-controlled multifunctional vehicle system, a vehicle, a use, a method, a program element and a computer-readable medium.

The exemplary embodiments described relate in equal measure to the navigation system, the vehicle, the use, the method, the program element and the computer-readable medium.

In line with one exemplary embodiment of the invention, a navigation system for a complex menu-controlled multifunctional vehicle system is specified, wherein the navigation system has a navigation unit, a man-machine interface (MMI or HMI) and a communication link. The communication link is designed to provide bidirectional communication between the man-machine interface and the navigation unit, the man-machine interface and the navigation unit being separate units which are designed to communicate with one another via the communication link.

The two units (MMI and navigation unit) are accommodated in separate appliances. In line with a further exemplary embodiment of the invention, the man-machine interface and the navigation unit are designed to be arranged at separate positions in the vehicle. This resolved design thus allows the vehicle navigation and the MMI to be developed and installed in the vehicle separately. In particular, this allows both appliances to be fitted at different locations in the vehicle.

By way of example, the man-machine interface is installed in the field of vision of the driver and the navigation portion (navigation unit) is installed in the glove box of the vehicle.

In line with a further exemplary embodiment of the invention, the navigation unit is designed for mobile communication with the man-machine interface via the communication link. Both units can thus be connected by cable or by radio. This connection is used to interchange only the respective required data.

The wireless transmission between the MMI and the navigation unit (and vice versa) is effected by WLAN (e.g. 802.11p), Bluetooth, ZigBee or WiMax, for example.

In line with a further exemplary embodiment of the invention, the navigation system is designed to transmit information from the navigation unit to the man-machine interface for the purpose of evaluating data located in the man-machine interface.

By way of example, the MMI has a dedicated computation unit and a dedicated data memory. It is therefore possible for the information which is to be presented to be handled within the MMI. The way in which this information is to be handled or presented can be controlled and inspected by the navigation unit, for example.

In line with a further exemplary embodiment of the invention, the navigation unit is a module of a driver assistance system. When the text below refers to “navigation unit”, this is intended to be understood to mean a simple navigation module (see reference symbol 120 in FIG. 1) or else a complex system (see reference symbol 130 in FIG. 1) which has both a navigation module and appropriate computation units and sensor systems, possibly in combination with a driver assistance system (see reference symbol 125 in FIG. 1).

In line with a further exemplary embodiment of the invention, the man-machine interface is designed to be partly integrated in a windshield of the vehicle or in front of a speed indicator of the vehicle. In this case, the graphical information is depicted on the windshield, for example. The audible output can be provided by loudspeakers arranged elsewhere. Control commands are input by voice control or using a mechanical input apparatus which is arranged on the central console of the vehicle or is integrated in a mobile appliance (PDA, mobile telephone, etc.), for example.

This allows the driver to record the graphical information without being distracted from what is happening in the traffic too greatly.

In line with a further exemplary embodiment of the invention, the navigation system also has a sensor apparatus for ascertaining a head position for the driver or the passenger relative to a display unit of the man-machine interface.

In line with a further exemplary embodiment of the invention, the navigation system has a computation unit for distorting information which is to be displayed on the display unit. The distortion is effected such that the information to be displayed is overlaid with the surroundings of the vehicle, as perceived by the driver or passenger, realistically or correctly from the point of view of the driver or passenger. The distortion is effected on the basis of the head position ascertained by the transmission apparatus. It is also possible for the distortion to be adjusted manually by the user by virtue of his operating an appropriate alignment apparatus. In this way, the user can manually overlay the displayed information with the surroundings of the vehicle, as perceived by him, realistically.

In line with a further exemplary embodiment of the invention, the navigation system has a laser projector for projecting the data which are to be displayed onto a windshield of the vehicle. In this case, the windshield may have a laser display which is used to visually display the impinging laser beam even better than on a normal windshield.

As an alternative to a laser projector and a laser display, it is also possible for a head up display to be provided which involves a graphic from a monitor being projected onto the windshield by means of a mirror arrangement.

In line with a further exemplary embodiment of the invention, the navigation system has a mobile navigation unit for providing map material for the navigation unit (which is permanently installed in the vehicle).

As already stated, it is possible, in line with a further exemplary embodiment of the invention, for this mobile navigation unit also to be used for controlling the installed navigation unit.

In line with a further exemplary embodiment of the invention, the mobile navigation unit is designed to transmit a selected portion of the map material stored in the mobile navigation unit.

In this way, it is possible to minimize the data traffic, since in each case only the currently required portion of the digital map is transmitted to the navigation unit (which is installed in the vehicle). In this case, provision may be made for the transmitted map detail to be of a definable size which is oriented to the average vehicle speed, for example, so that the vehicle is situated within the map section for at least one minute (or at least for another, user-selectable period).

In line with a further exemplary embodiment of the invention, the navigation system is designed to use a screen of the mobile navigation unit to display data which are not presented by the MMI. In other words, the screen of the mobile navigation unit can be used as an addition to the MMI of the vehicle. By way of example, the mobile navigation unit has a piece of software installed on it which is not available to the permanently installed navigation unit or to the MMI. It is thus possible for the mobile navigation unit to supplement the permanently installed navigation unit and the MMI in this way.

In line with a further exemplary embodiment of the invention, a vehicle having a navigation system as described above is specified.

In line with a further exemplary embodiment of the invention, the navigation system in the vehicle is designed such that the MMI and the navigation unit are arranged at separate locations in the vehicle.

This allows the data which are stored and processed in the navigation unit to be protected from damage to a high degree, whereas the MMI does not meet such high safety requirements. It is thus possible to make a distinction on the basis of safety-critical and less safety-critical data, components, etc., which are then accommodated either in the navigation unit or in the MMI.

This allows costs to be saved during production, since the less safety-critical components do not need to be produced with such high outlay.

In line with a further exemplary embodiment of the invention, the use of a navigation system as described above in a vehicle is specified.

In line with a further exemplary embodiment of the invention, a method for assisting a driver of a vehicle is specified in which a bidirectional communication link is provided between a man-machine interface and a navigation unit for a complex menu-controlled multifunctional vehicle system. In addition, data located in the man-machine interface are actuated via the communication link, the man-machine interface and the navigation unit being separate units which are designed to communicate with one another via the communication link.

In line with a further exemplary embodiment of the invention, a program element is specified which, when executed on a processor, instructs the processor to perform the steps described above.

In this case, the computer program element may be part of a piece of software, for example, which is stored on a processor for the vehicle management. Similarly, the computer program element can be used in an electronic braking assistant. In this case, the processor may likewise be the subject matter of the invention. In addition, this exemplary embodiment of the invention comprises a computer program element which uses the invention right from the outset, as well as a computer program element which prompts an existing program to use the invention by virtue of an update.

In line with a further exemplary embodiment of the invention, a computer-readable medium is specified which stores a program element which, when executed on a processor, instructs the processor to perform the steps described above.

The term “digital maps” is also intended to be understood to mean maps for advanced driver assistance systems (ADASs), without a navigation taking place.

By way of example, the vehicle is a motor vehicle, such as a car, bus or heavy goods vehicle, or else is a rail vehicle, a ship, an aircraft, such as a helicopter or airplane.

In addition, it should be pointed out that, within the context of the present invention, GPS is representative of all global navigation satellite systems (GNSSs), such as GPS, Galileo, GLONASS (Russia), Complex (China), IRNSS (India), etc.

Preferred exemplary embodiments of the invention are described below with reference to the figures.

### BRIEF DESCRIPTION OF THE DRAWINGS

FIG. 1 shows a schematic illustration of a navigation system based on an exemplary embodiment of the invention.

FIG. 2 shows a schematic illustration of a sensor for sensing a relative position for the head of the driver based on an exemplary embodiment of the invention.

FIG. 3 shows a vehicle based on an exemplary embodiment of the invention.

FIG. 4 shows a flowchart for a method based on an exemplary embodiment of the invention.

### DETAILED DESCRIPTION OF THE PREFERRED EMBODIMENTS

The illustrations in the figures are schematic and not to scale.

In the description of the figures which follows, the same reference numerals are used for the same or similar elements.

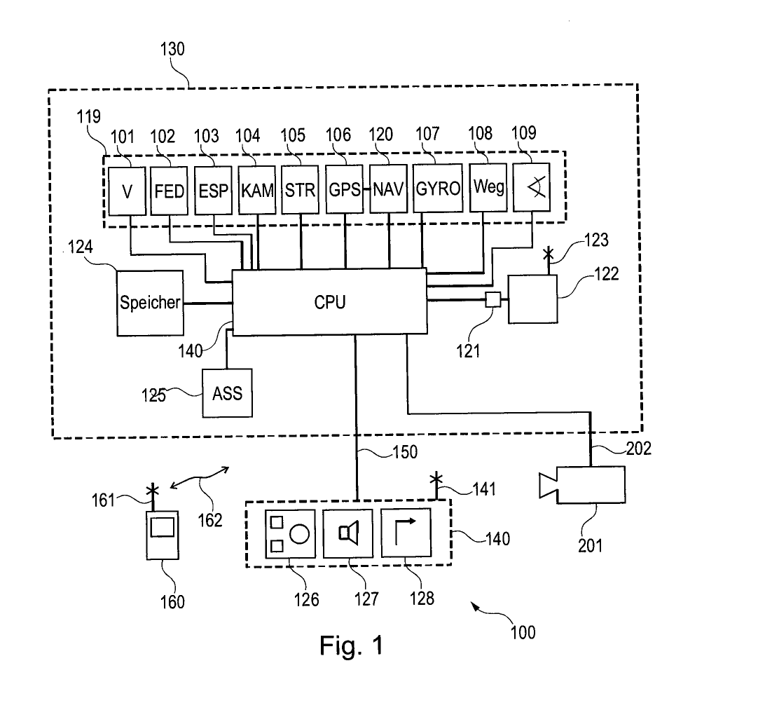

FIG. 1 shows a schematic illustration of components of a navigation system 100 for installation in a vehicle. The navigation system 100 has a navigation unit 130, a man-machine interface 140, which is connected to the navigation unit 130 via the communication link 150, and also has a sensor 201 and a mobile navigation unit 160.

The data to be transmitted by the navigation system 100, which are transmitted from the control unit 140, which is in the form of a CPU, for example, to the communication unit 122, can be encrypted using an encryption device 121. Similarly, the received data which are transmitted from the communication unit 122 to the control unit 140 are decrypted by the encryption unit 121. The communication unit 122 has an antenna 123 for the data transmission.

In principle, the navigation unit 130 can use this antenna 123 and the communication device 122 to communicate with the MMI 140 wirelessly. For this, the MMI 140 likewise has an appropriate antenna 141.

It is also possible to use a separate wireless communication link for the communication between the MMI 140 and the navigation unit 130, in which case the navigation unit 130 then also has an additional communication unit (not shown in FIG. 1).

The MMI 140 has an input unit 126, an audible output unit 127 and a graphical output unit 128, for example in the form of a monitor.

The communication link 150 between the MMI and the navigation unit 130 may be in either wired or wireless form. It is also possible for both a wireless and a wired connection to be provided beside one another.

The input unit 126 can be used to make various adjustments to the navigation unit 130 and to the MMI.

The visual output unit (for example in the form of a monitor) 128 can be used to output routing information. Furthermore, the routing information can also be output via the audible output unit 127. Output via the audible output unit 127 has the advantage that the driver is less distracted from what is currently happening in the traffic.

A memory element 124, which is connected to the control unit 140 or is integrated in the control unit 140, stores the digital map data (e.g. as navigation map data) in the form of data records. By way of example, the memory element 124 also stores additional information about traffic restrictions, infrastructure devices and the like in association with the data records.

In addition, a driver assistance unit 125 is provided which is supplied with the digital map data or other information (for example sensor or measurement information).

For the purpose of determining the current vehicle position, the navigation unit has a navigation module 120 with a satellite navigation receiver 106, which is designed to receive positioning signals from Galileo satellites or GPS satellites, for example. Naturally, the satellite navigation receiver may also be designed for other satellite navigation systems.

The satellite navigation receiver 106 is connected to the control unit 140. The navigation module 120 is also connected to the control unit 140. In addition, there is a direct connection between the navigation module 120 and the satellite navigation receiver 106. It is therefore possible for the GPS signals to be transmitted directly to the CPU 140.

Since the positioning signals can't always be received in city centers, for example, the sensor system 119 of the navigation system 100 also has a direction sensor 107, a distance sensor 108, a steering wheel angle sensor 109, a spring excursion sensor 102, an ESP sensor system 103 and possibly an optical detector 104, for example in the form of camera, for the purpose of performing compound navigation. It is also possible for a beam sensor 105 (radar or lidar sensor) to be provided. In addition, the sensor system 119 has a speedometer 101.

The signals from the GPS receiver 106 and from the other sensors are handled in the control unit 140. The vehicle position ascertained from said signals is aligned using map matching by means of road maps. The routing information obtained in this manner is transmitted to the MMI 140 and is output on the monitor 128 (which may also be in the form of a laser display or head up display), for example. It is also possible for the handling or a portion of the handling of the signals to be performed directly in the MMI 140. If there is an improved piece of evaluation or presentation software available, for example, this can be loaded onto the MMI or can be installed together with a new (replacement) MMI. This allows rapid and inexpensive retrofitting.

In addition, the system 100 has a sensor 201, for example in the form of a camera or a laser scanner. The sensor 201 is capable of sensing the relative head position of the driver or else of the passenger relative to the windshield. The sensor unit 201 is connected by means of the data line 202 to the navigation unit 130 or to the computation unit 140 thereof. This connection may be wired or wireless.

In addition, a mobile navigation unit 160 having an antenna 161 is provided which can use the wireless communication link 162 to communicate with the navigation unit 130. It is also possible for the mobile communication unit 160 to be connected to the permanently installed navigation unit 130 by means of a data cable.

The navigation system described above is a complex menu-controlled multifunctional vehicle system which has a plurality of functional components.

The separate arrangement and splitting of the man-machine interface 140 and the navigation unit 130 allows navigation software which is part of a permanently incorporated driver assistance system to be connected to a transportable man-machine interface. In this case, the navigation software remains unchanged, whereas the man-machine interface can be improved in short cycles and hence can become ever more realistic in presentation. It is therefore possible to permit a high safety standard for the navigation software, which is a necessity for driver assistance systems, without dispensing with an up-to-date graphical representation.

By way of example, the MMI has a small screen 128 which is fitted in front of the center of rotation of the speedometer needle of the vehicle's speed indicator. Overall, it is possible for the MMI to be designed to be significantly slimmer than in the case of an integrated solution. This may be advantageous particularly in respect of possible impairment of vision and safety in the event of an accident.

Instead of a navigation appliance 120, it is also possible to use a piece of map software. In this case, no route guidance via the man-machine interface is possible. However, it is possible for current road signs, speed restrictions, etc., to be displayed. In this case, the route guidance can also be undertaken by the mobile navigation appliance 160.

The separation of navigation and MMI allows both parts to be developed on the basis of different safety criteria. By way of example, the MMI may be designed to have a relatively low safety standard, whereas the navigation unit 130 meets a high safety standard. Furthermore, both units can be replaced, serviced or renovated independently of one another.

It is also possible for the display device 128 of the MMI to be in the form of a windshield laser display. In this case, the real surroundings of the vehicle as perceived by the driver are overlaid with the presentation of a road map, for example. In this way, the driver can sense important information when he simply looks through the windshield. By way of example, a sensor 201 provided specifically for this purpose ascertains the head position of the driver relative to the display 128. In this way, the system can identify how the information to be presented to the driver (for example in the form of a vector graphic) needs to be distorted so that the graphic and reality overlap as well as possible.

So as not to obscure reality and to keep down the power requirement, the graphic is preferably not a bitmap graphic but rather a vector graphic, such as can be projected by means of a laser or a two-axis deflector unit. It is therefore possible for the projector and the sensor to be retrofitted. It is also possible for the projector to be integrated into a mobile terminal. By way of example, the projector can be integrated into a mobile telephone, which is then positioned at a suitable location in the vehicle. An appropriately aligned holding apparatus may be provided for the positioning, for example.

The information presented on the display device 128 (windshield) may comprise what is known as convenience information, such as the path to be taken, an intersection road, possibly road names, house numbers, gas stations, letterboxes, restaurants, attractions, the selected radio channel, and the like.

It is also possible for safety-related information to be overlaid. Thus, by way of example, the laser display can be combined with a position-finding system, so that a pedestrian, an obstacle or an oncoming vehicle on a collision course is marked in the field of vision after it has been identified by a suitable sensor system 119.

It is also possible for the information which is important to operation of the vehicle, such as speed, gear, engine speed, tank, temperature, time of day and warning lamps, to be shown as required. It is then merely necessary to ensure a placement which does not disturb the driver.

The laser display (or the laser) can be adjusted manually so that reality and depiction overlap with precise congruence. In this case, a head sensor is not required. If the position is not sensed in the viewing direction of the eyes then the driver adjusts the display by hand such that he achieves a good overlap between map and reality from an average head position.

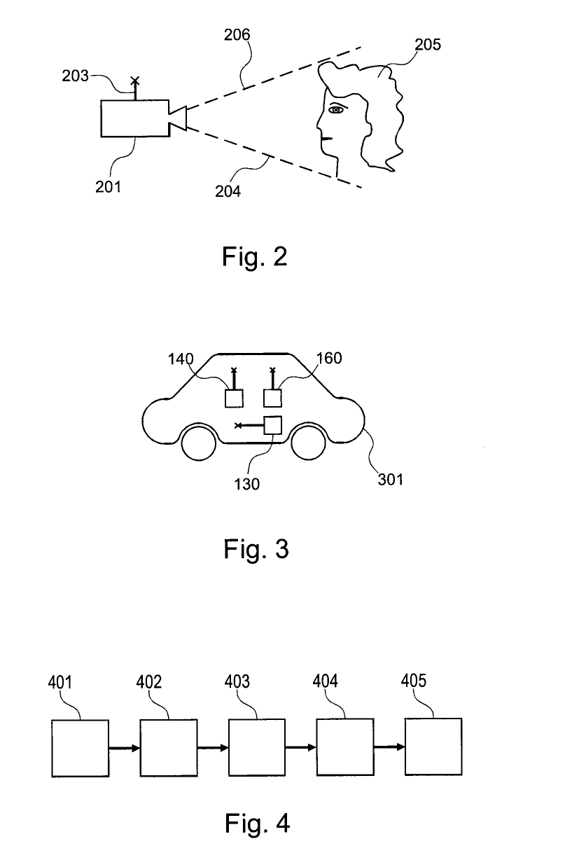

FIG. 2 shows a head sensor based on an exemplary embodiment of the invention. By way of example, the sensor 201 is in the form of a CCD or CMOS head sensor. For the purpose of communication with the computation unit 140, an antenna 203 is provided, for example. A data line may also be provided.

In FIG. 2, the head of the driver is denoted by the reference symbol 205, and the image area of the image sensed by the detector 201 is symbolized by the dashed lines 204 and 206.

By way of example, the sensor 201 comprises a simple stereoscopic infrared digital camera and essentially senses the head position of the driver or passenger and the distance to the head. In this case, a marker may be helpful which is in the form of a red dot, for example, which is stuck onto the forehead.

Using the sensed head position and possibly an additionally manual alignment of the position of the projector relative to the windshield, the map which is projected remains congruent with reality over a wide range of head movement.

In a further exemplary embodiment, the head sensor 201 is in the form of a laser scanner (for example in the form of an “off position” laser scanner). In this case, an infrared laser scans the interior of the vehicle in a manner which is not visible to the driver and ascertains the head position of the driver from a propagation time difference and direction.

Advantageously, the driver is distracted to a lesser extent from the road ahead. In addition, the illustrated solution allows conventional display instruments to be saved. A lot of different information can be presented when required such that the display is not overloaded with details and hence the driver's attention could not be overtaxed.

In addition, the driver can have additional functions displayed and arranged and can adjust these displays and the arrangement according to need. Certain displays may be the same for all drivers (for example important information, such as speed, distance, warning lamps). Other settings and displays can be defined on the basis of driver as a “style”.

The simple design of this universal display instrument means that it can also be integrated into a mobile terminal and hence can be retrofitted even for older vehicles. In particular, both the driver and the passenger can each be provided with a dedicated display which contains different information, for example. This is of particular interest for driving schools.

In today's vehicles, there are two solutions for navigation: firstly, there are mobile navigation appliances which can be taken into the vehicle but which cannot access resources available in the vehicle (apart from power). There may also be other navigation appliances integrated in the vehicle. This means that they can easily be customized to suit the vehicle and can access all the available information (sensors, etc.) and input/output options. However, these permanently installed, integrated navigation appliances are quickly outdated.

In line with a further aspect of the invention, the navigation system additionally has a mobile navigation appliance 160.

FIG. 3 shows a vehicle having a navigation system as described above, including a mobile navigation appliance 160, based on an exemplary embodiment of the invention.

The vehicle 301 has a built-in integrated navigation unit 130 which, however, does not have any map material or inadequate or outdated map material. If a mobile navigation appliance 160 is now connected, the map data are transmitted from the mobile navigation appliance 160 to the integrated navigation unit 130. The transmission is effected via a radio interface or by wire.

In this case, only those details from the map which are relevant to the current driving situation, e.g. that is to say cover the next 10 minutes of driving, and to the planned route are transmitted. These data continue to be stored in the integrated navigation appliance even if the connection to the mobile appliance is interrupted. This ensures that data continue to be available even if no mobile navigation appliance is connected.

In this regard, it is important for the data from the mobile navigation appliance to be converted to the data format of the integrated appliance. There are three suitable methods for this:
Complete transformation of the data takes place in the mobile appliance 160. This is a flexible variant.
The mobile appliance transforms the data into a raw format, and the integrated appliance 130 transforms this raw format into the internally used format.
The whole transformation takes place in the integrated appliance 130, 140. This requires the conversion routines to be able to be updated retrospectively too in order to allow customization to suit new generations of mobile appliances.

Functions which are not contained in the integrated navigation software are additionally (e.g. as a second screen or split screen) presented by the mobile appliance. Similarly, the mobile appliance can be used for presenting the menu, whereas the integrated navigation system shows only the navigation advice. Hence, depending on the mobile appliance used, different additional functions are obtained and hence differentiation options for the respective manufacturers of the systems.

If a plurality of mobile appliances are used, e.g. a mobile navigation appliance and a smartphone with a navigation software, then prescribed criteria are used to select which map data are loaded into the integrated navigation unit. By way of example, such criteria may be the currentness of the map data, the accuracy, the compatibility, etc. When additional functions are presented on the mobile appliances, either the user can decide which function is presented on which appliance, or one of the systems (preferably the integrated system) decides this. This selection of the functions is stored (particularly when the user has selected it), for example, so that it is available again for the next use. In this case, the storage of the configuration can be distinguished on the basis of
mobile system (that is to say separately for each system A, B, C etc.),
combination of systems (that is to say for each combination A+B, B+C, A+C, etc.),
general additional function independent of the system. This is intended to be understood to mean that, by way of example, a specific function is used neither for A nor for B or C or that another specific function is always used or that a combination of functions is selected.

The buffering of the data from the mobile appliance and the completely present navigation software in the integrated system mean that navigation is possible even if there is currently no connection to a mobile appliance. The use of the screen of the mobile appliance for additional information increases the size of the area which can be used for the actual navigation on the screen of the integrated navigation unit.

FIG. 4 shows a flowchart for a method based on an exemplary embodiment of the invention. In step 401, a bidirectional communication link is provided between a man-machine interface and a navigation unit for a complex menu-controlled multifunctional vehicle system. In addition, a communication link is set up between the installed navigation unit and a mobile navigation unit. In step 402, map data are transmitted from the mobile appliance to the installed navigation unit. In step 403, the map data are buffered in the installed navigation unit. In step 404, the screen of the mobile appliance is used to present additional information or for functions which are not covered by the integrated software. Furthermore, additional information can be stored. In step 405, the data located in the MMI are actuated via the relevant communication link.

In addition, it should be pointed out that “comprising” and “having” do not exclude other elements or steps, and “a” or “an” does not exclude a large number. Furthermore, it should be pointed out that features or steps which have been described with reference to one of the above exemplary embodiments can also be used in combination with other features or steps from other exemplary embodiments described above. Reference symbols in the claims should not be regarded as restrictions.

1. A navigation system for a menu-controlled multifunctional vehicle system, said navigation system comprising:
a navigation unit;
a man-machine interface; and
a communication link for providing bidirectional communication between the man-machine interface and the navigation unit;
wherein the man-machine interface and the navigation unit are separate units configured to communicate with one another via the communication link.

2. The navigation system as claimed in claim 1,
wherein the man-machine interface and the navigation unit are designed to be arranged at separate positions in the vehicle.

3. The navigation system as claimed in claim 1,
wherein the navigation unit is designed for mobile communication with the man-machine interface via the communication link.

4. The navigation system as claimed in claim 1,
configured to transmit information from the navigation unit to the man-machine interface for the purpose of actuating data located in the man-machine interface.

5. The navigation system as claimed in claim 1,
wherein the navigation unit is a module of a driver assistance system.

6. The navigation system as claimed in claim 1,
wherein the man-machine interface is configured to be integrated in a windshield of the vehicle or in front of a speed indicator of the vehicle.

7. he navigation system as claimed in claim 1, further comprising:
a sensor apparatus for ascertaining a head position for the driver or for the passenger relative to a display unit of the man-machine interface.

8. The navigation system as claimed in claim 7, further comprising:
a computation unit for distorting information which is to be displayed on the display unit, wherein the information to be displayed is overlaid with the surroundings of the vehicle, as perceived by the driver or passenger, correctly from the point of view of the driver or passenger;
wherein the distortion is effected on the basis of the head position ascertained by the sensor apparatus.

9. The navigation system as claimed in claim 7, further comprising:
a laser projector for projecting the data onto a windshield of the vehicle.

10. The navigation system as claimed in claim 1, further comprising:
a mobile navigation unit for providing map material for the navigation unit.

11. The navigation system as claimed in claim 10,
wherein the mobile navigation unit is configured to transmit a selected portion of the map material stored in the mobile navigation unit.

12. The navigation system as claimed in claim 10,
configured to use a screen of the mobile navigation unit to display data which are not presented by the man-machine interface.

13. A vehicle having a navigation system as claimed in claim 1.

14. The vehicle as claimed in claim 13,
wherein the man-machine interface and the navigation unit are arranged at separate locations in the vehicle.

15. The use of a navigation system as claimed in claim 1 in a vehicle.

16. A method for assisting a driver of a vehicle, said method having the following steps:
providing a bidirectional communication link between a man-machine interface and a navigation unit for a complex menu-controlled multifunctional vehicle system;
actuating data located in the man-machine interface via the communication link;
enabling communication between the man-machine interface and the navigation unit being separate units via the communication link.

17. A program element which, when executed on the processor, instructs the processor to perform the following steps:
provision of a bidirectional communication link between a man-machine interface and a navigation unit for a complex menu-controlled multifunctional vehicle system;
actuation of data located in the man-machine interface via the communication link;
the man-machine interface and the navigation unit being separate units which are configured to communicate with one another via the communication link.

18. A computer-readable medium which stores a program element which, when executed on a processor, instructs the processor to perform the following steps:
provision of a bidirectional communication link between a man-machine interface and a navigation unit for a complex menu-controlled multifunctional vehicle system;
actuation of data located in the man-machine interface via the communication link;
the man-machine interface and the navigation unit being separate units which are configured to communicate with one another via the communication link.
